(19) United States
(12) Patent Application Publication
(10) Pub. No.: US 2010/0037259 A1
(43) Pub. Date: Feb. 11, 2010

(54) EPG SERVER AND EPG PROCESSING METHOD

(75) Inventors: I-Chih Chen, Tu-Cheng (TW); Kuo-Chung Yang, Tu-Cheng (TW); Deng-Rung Liu, Tu-Cheng (TW); Sheng-Yu Chiang, Tu-Cheng (TW); Chiao-Ying Wu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/402,472

(22) Filed: Mar. 11, 2009

(30) Foreign Application Priority Data
Aug. 8, 2008 (CN) 200810303619.4

(51) Int. Cl. H04N 5/445; H04N 7/173

(52) U.S. Cl. 725/39; 725/114

(57) ABSTRACT

An electronic program guide (EPG) server bridges at least one middleware server with at least one set-top box (STB). The EPG server transmits an EPG request to the middleware server to receive electronic program guides comprising one or more different file formats to the middleware server and transforms the EPGs into EPGs having a preset file format. The EPG server further transmits the EPGs with the preset file format to the at least one STB.

### BACKGROUND

1. Technical Field

Embodiments of the present disclosure relate to TV networks, and particularly to an electronic program guide (EPG) server and an EPG processing method.

2. Description of Related Art

In a broadcasting digital TV, a TV broadcaster provides not only video programs, but also extra-program information and other information to aid users in selecting programs. Consequently, an electronic program guide (EPG) has been developed, which provides an easy and friendly user interface to browse and query program information.

However, different TV broadcasters provide EPGs with different file formats, and therefore set-top boxes (STBs) need different algorithms and interfaces to display the different EPGs. In view of the foregoing, it is desirable to provide a better EPG server and EPG processing.

### BRIEF DESCRIPTION OF THE DRAWINGS

FIG. 1 depicts a schematic diagram of an application environment of an electronic program guide (EPG) server.

FIG. 2 depicts a block diagram of one exemplary embodiment of the EPG server of the present disclosure.

FIG. 3 depicts a flowchart of one exemplary embodiment of an EPG processing method of the present disclosure.

### DETAILED DESCRIPTION

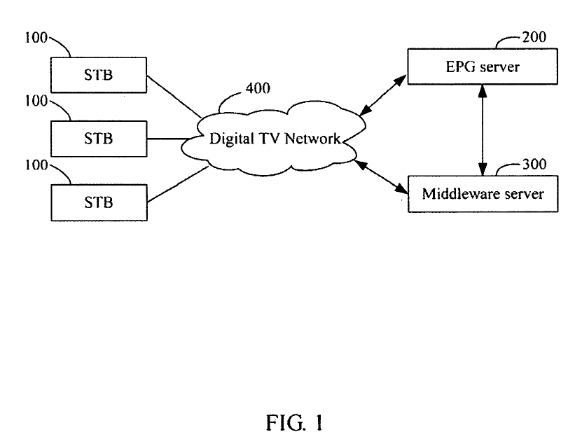

Referring to FIG. 1, a schematic diagram of an application environment of an electronic program guide (EPG) server 200 shows the EPG server 200 bridges at least one middleware server 300 with at least one set-top box (STB) 100 over a digital TV network 400. The middleware server 300 saves EPGs from various TV networks and/or broadcasting stations, where the EPGs may have one or more file formats. The EPG server 200 receives the EPGs, comprising one or more different file formats, from the at least one middleware server 300, transforms the EPGs into EPGs with a preset file format, and finally transmits the EPGs with the preset file format to the at least one STB 100 over the digital TV network 400.

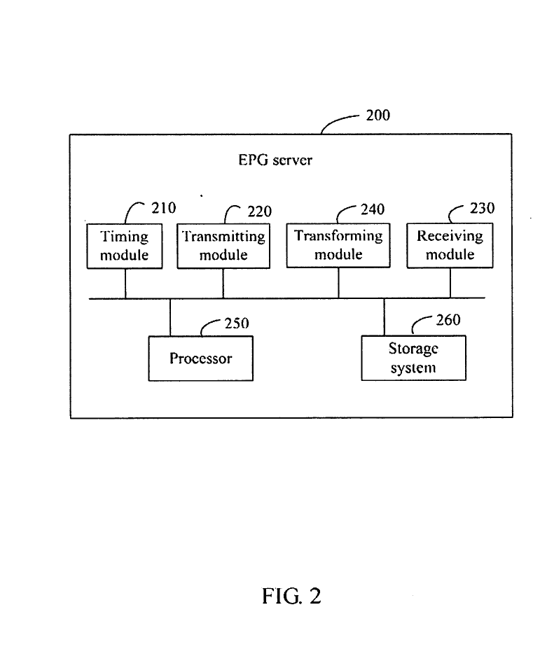

Referring to FIG. 2, a block diagram of the EPG server 200 shows the EPG server 200 comprises a timing module 210, a transmitting module 220, a receiving module 230, and a transforming module 240. Furthermore, the EPG server 200 comprises a processor 250 and a storage system 260. In one embodiment, programmable code in the modules 210, 220, 230, 240 are stored in the storage system 260 and are executed by the processor 250.

The transmitting module 220 is configured for transmitting an EPG request to the middleware server 300 to obtain EPGs from the middleware server 300. It may be understood, as mentioned above, that these EPGs may comprise different file formats. The middleware server 300 sends latest EPGs with the different file formats to the EPG server 200 after receiving the EPG request from the EPG server 200. In one example, the different file formats may comprise the hypertext markup language (HTML) format, and text format.

The timing module 210 is configured for generating and sending an periodic indication to transmit the EPG request to the middleware server 300. In one example, the period is every 24 hours. In another example, the period may be different, for example, every 10 minutes or every week.

The transmitting module 220 is further configured for transmitting the EPG request to the middleware server 300 according to the indication from the timing module 210 so as to update the EPGs with the different file formats.

In another embodiment, the timing module 210 may be omitted, the transmitting module 220 may transmit the EPG request to the middleware server 300 according to a user-selected instruction or an update notice of the middleware server 300.

The receiving module 230 is configured for receiving the EPGs with the different file formats from the middleware server 300.

The transforming module 240 is configured for transforming the EPGs comprising one or more different file formats into EPGs having a preset file format. In one embodiment, the preset file format may comprise the extensible markup language (XML) format. The transforming module 240 is further configured for compressing the EPGs with the preset file format according to the Moving Picture Experts Group (MPEG) standard. The transmitting module 220 transmits the compressed EPGs to the at least one STB 100. It may be understood that other formats other than the MPEG standard may be used.

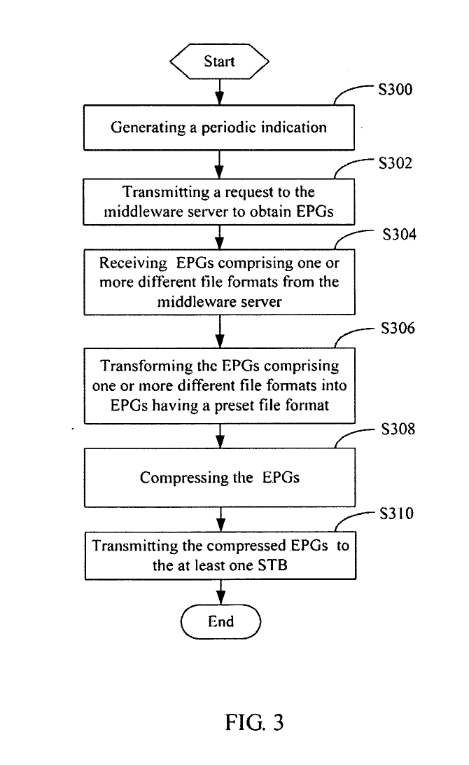

Referring to FIG. 3, a flowchart of one exemplary embodiment of an EPG processing method in shown. The EPG processing method is applied in the EPG server 200. Here the EPG processing method employed by the EPG server 200 is accomplishment by the function modules shown in FIG. 2. Depending on the embodiment, additional blocks may be added, others deleted, and the ordering of the blocks may be changed.

In block S300, the timing module 210 generates a periodic indication. As mentioned above, the periodic indication is adjustable, that is, the user can set the period according to different requirements. In one example, the period is set to be 24 hours, such that the EPG server 200 updates the EPG once every 24 hours. In another example, the period of the timing module 210 may be different, such as every 2 weeks.

In block S302, the transmitting module 220 transmits a request to the middleware server 300 to obtain EPGs comprising one or more different file formats from the middleware server 300. In one embodiment, the transmitting module 220 transmits the EPG request after receiving the indication from the timing module 210.

In block S304, the receiving module 230 receives the EPGs comprising one or more different file formats from the middleware server 300. In one embodiment, one or more different file formats may comprise, for example, the HTML format and the text format.

In block S306, the transforming module 240 transforms the EPGs comprising one or more different file formats into EPGs having a preset file format. In one embodiment, the preset file format may comprise the XML format.

In block S308, the transforming module 240 compresses the EPGs with the preset file format, according to the MPEG standard.

In block S310, the transmitting module 220 transmits the compressed EPGs to the at least one STB 100.

The STB 100 decompresses the compressed EPGs and displays the EPGs with the preset file format onto a display system. Accordingly, a user may select a program or order services from the middleware server 300 according to the EPGs with the preset file format. In one embodiment, the services may comprise multimedia content, weather forecasts, and so on. The middleware server 300 generates a purchase certificate back to the user, and then the user receives the service from the middleware server 300 via the purchase certificate.

The EPG server 200 and the EPG processing method of the present disclosure provide the EPGs in the preset file format such that the STB 100 can display the EPGs of different channels using the same algorithms and interface. The EPGs are stored in the STB 100, and therefore users of the STB 100 do not need to consistently access the middleware server 300 to obtain EPGs, which can decrease the load of the middleware server 300. When the users want to select a program, the STB 100 can display the EPGs quickly, without transmitting the request to the middleware server 300, and respond to the users promptly.

The description of the present disclosure has been presented for purposes of illustration and description, and is not intended to be exhaustive or limited to the disclosure in the form disclosed. Many modifications and variations will be apparent to those of ordinary skill in the art. Various embodiment were chosen and described in order to best explain the principles of the disclosure, the practical application, and to enable others of ordinary skill in the art to understand the disclosure for various embodiments with various modifications as are suited to the particular use contemplated.

What is claimed is:

1. An electronic program guide server for bridging at least one middleware server with at least one set-top box (STB), the electronic program guide server comprising:
a transmitting module configured for transmitting an electronic program guide request to the middleware server, to receive electronic program guides from the middleware server, wherein the electronic program guides comprise different file formats;
a receiving module configured for receiving the electronic program guides from the middleware server;
a transforming module configured for transforming the electronic program guides into electronic program guides having a preset file format;
wherein the transmitting module is further configured for transmitting the electronic program guides with the preset file format to the at least one STB.

2. The electronic program guide server as claimed in claim 1, further comprising a timing module configured for periodically generating and sending a reminder indication to the transmitting module to transmit the electronic program guide request to the middleware server.

3. The electronic program guide server as claimed in claim 2, wherein the transmitting module is further configured for transmitting the electronic program guide request to the middleware server according to the reminder indication so as to update the electronic program guides comprising the different file formats.

4. The electronic program guide server as claimed in claim 1, wherein the different file formats comprise the hypertext markup language (HTML) format and the text format, and the preset file format comprises the extensible markup language (XML) format.

5. The electronic program guide server as claimed in claim 1, wherein the transforming module is further configured for compressing the electronic program guides.

6. The electronic program guide server as claimed in claim 5, wherein the transmitting module is further configured for transmitting the compressed electronic program guides to the STB.

7. An electronic program guide processing method applied in an electronic program guide server bridging at least one middleware server with at least one set-top box (STB), the electronic program guide processing method comprising:
transmitting an electronic program guide request to the middleware server to receive electronic program guides from the middleware server, wherein the electronic program guides comprise one or more different file formats;
receiving the electronic program guides from the middleware server;
transforming the electronic program guides to electronic program guides having a preset file format; and
transmitting the electronic program guides comprising the preset file format to the STB.

8. The electronic program guide processing method as claimed in claim 7, further comprising the electronic program guide server generating and sending a periodic indication to transmit the electronic program guide request to the middleware server.

9. The electronic program guide processing method as claimed in claim 7, wherein the one or more different file formats comprise the hypertext markup language (HTML) format and the text format, the preset file format comprises the extensible markup language (XML) format.

10. The electronic program guide processing method as claimed in claim 7, further comprising:
compressing the electronic program guides; and
transmitting the compressed electronic program guide to the at least one STB.
